(19) United States
(12) Patent Application Publication
(10) Pub. No.: US 2023/0137795 A1
(43) Pub. Date: May 4, 2023

(54) METHOD AND SYSTEM FOR VALIDATION OF A CHARGING DATA SET

(71) Applicant: AUDI AG, Ingolstadt (DE)

(72) Inventors: Jürgen HORVATH, Pfakofen (DE); Franz LANKES, Ingolstadt (DE)

(21) Appl. No.: 17/980,441

(22) Filed: Nov. 3, 2022

(30) Foreign Application Priority Data
Nov. 4, 2021 (DE) 102021128708.1

(51) Int. Cl. B60L 53/66

(52) U.S. Cl. CPC B60L 53/665

(57) ABSTRACT

Methods for validation of a first charging data set, regarding a charging process of a motor vehicle at a first charging station and detected by the first charging station, comprise detecting a respective second charging data set, by a second charging station, regarding at least one respective second charging process during which the same motor vehicle is charged and/or the charging process is initiated and/or terminated by the same user, wherein the fulfillment of an error condition is tested, the fulfillment of which indicates the invalidity of the first and/or the second charging data set and is dependent on both the first charging data set and the second charging data set.

### BACKGROUND

### Technical Field

Embodiments of the invention relate to a method for validation of a first charging data set regarding a charging process of a motor vehicle at a first charging station and detected by the first charging station. In addition, embodiments of the invention relate to a system for validation of a first charging data set.

### Description of the Related Art

Motor vehicles, especially electric vehicles or plug-in hybrids, and their energy accumulators, may at times be charged not only at private charging stations, but also at publicly accessible charging stations. Typically, charging fees are assessed for this, which may depend on the charged energy amount, in turn depending on the charging time, and on occasion the parking time in the area of the charging station. Due to technical errors, or also manipulation attempts, wrong registrations of the charging or parking times may occur, for example if the end of the charging process is not correctly recognized, or if third-party vehicles are charged at the expense of a user on account of a falsified user or vehicle identification.

In order to rule out at least some of the mentioned error sources or manipulation possibilities, the document DE 10 2012 011 773 A1 proposes terminating the charging process only when a central computer acknowledges the reception of the billing-relevant data from the respective charging station. With this solution, however, it is a problem that server down time or communication disruptions may result in the motor vehicle being blocked from driving away for a lengthy period of time, and so such a method can hardly gain sufficient user acceptance. Furthermore, it cannot rule out certain errors or manipulations, such as the use of a particular piece of identification by multiple vehicles or users.

### BRIEF SUMMARY

Some embodiments provide improved or supplemental steps for the recognizing of technical errors and/or manipulation attempts during charging processes of motor vehicles at charging stations, avoiding in particular the drawbacks described above.

Some embodiments provide a method of the kind mentioned above, wherein a respective second charging data set is detected by at least one second charging station, regarding at least one respective second charging process during which the same motor vehicle is charged and/or the charging process is initiated and/or terminated by the same user, wherein the fulfillment of an error condition is tested, the fulfillment of which indicates the invalidity of the first and/or the second charging data set and is dependent on both the first charging data set and the second charging data set.

It has been discovered that errors occurring especially frequently or systematically during charging processes and manipulation attempts can be recognized by checking the mutual consistency of charging data sets which have been registered in the course of different charging processes. As will be explained more closely below, it is possible to recognize in particular, on the basis of charging data sets which have been registered during different charging processes, when charging processes of the same motor vehicle at different charging stations apparently overlap or are situated so close together in time, according to these charging data sets, that is unrealistic based on the distance between the charging stations. Yet these are precisely the situations which occur, for example, if the ending of one charging process at a particular charging station is not correctly detected and when due to an error or a manipulation, the same identification is used for multiple users or motor vehicles.

Thus, especially in event of a repeated occurrence of such errors, the users or other parties involved, such as vehicle manufacturers or charging station operators, can be notified as to such errors, certain charging stations, users or motor vehicles can be blocked for charging, or the like.

The first and second charging data set can each describe a charging time interval in which the respective charging process occurs, wherein the error condition is fulfilled or it can only be fulfilled if the charging time interval of the first charging data set overlaps with the charging time interval of the second charging data set or at least one of the second charging data sets. Such an error condition is especially feasible when the charging data sets pertain to the charging of the same motor vehicle. Since a motor vehicle obviously cannot be charged by two distant charging stations at the same time, such an overlap implies in robust manner the existence of an error in one of the charging data sets.

The charging time interval can be considered as being, in particular, the time interval during which charging currents are flowing, or the time interval during which the motor vehicle is connected to a charging station, or the time interval during which the motor vehicle finds itself in a parking area associated with the charging station. A connecting of the motor vehicle to a charging station can typically be detected in any case by sensors at the charging station side. A motor vehicle parking in the associated parking area can be detected, for example, by a camera or other sensors of the charging station.

The first and second charging data set can each describe the charging time interval or a charging time interval in which the respective charging process occurs, wherein the error condition is fulfilled or it can only be fulfilled if a time distance between the beginning or end of the charging time interval of the first charging data set and the beginning or end of the charging time interval of the second charging data set or at least one of the second charging data sets falls below a time limit value. With the aid of such an error condition it is possible to recognize, for example, when charging time intervals at charging stations distant from each other occur in an implausibly short succession or when the same user had to perform actions for the initiating or terminating of a charging process at different charging stations within an implausibly short period of time. If the charging data sets, for example, pertain to charging processes at charging stations situated in different towns or at several tens or hundreds of km distance from each other, and if consecutive charging processes occur for the same vehicle or actions are performed by the same user within a few seconds or minutes, this is implausible, and therefore the error condition should be fulfilled in this case.

The time distance between the end of the earlier of the charging time intervals and the beginning of the later occurring charging time interval may be evaluated. This is especially feasible when considering charging processes of the same motor vehicle, since in this case, the motor vehicle must necessarily have moved between the charging stations between the charging processes, so that too short a sequence is not plausible.

Insofar as actions by the user on site are required for the initiating or terminating of the charging process, the evaluation of such an error condition may also be conducted when considering charging processes at different motor vehicles by the same user, since in this case the user must have moved between the corresponding charging stations between the end of the earlier charging time interval and the beginning of the later charging time interval. In consideration of charging processes of different motor vehicles which are initiated or terminated by the same user, the time distance between the respective beginning of the charging time intervals or between the respective ending of the charging time intervals may be compared against the time limit value, since actions of the user on site are typically required at the beginning or ending of the charging time interval, so that too short a succession of corresponding actions at distant charging stations might be implausible.

Some embodiments both check for an overlap of charging time intervals of different charging data sets and compare time distances against a time limit value. For example, it is an especially clear indication of errors or manipulations when an overlap of the charging time intervals is recognized for one pair of charging data sets and no overlap is present for another pair, but still the time distance is less than the time limit value. For example, it may be possible that the error condition is fulfilled only in this case, or that a triggering condition which puts out a message when fulfilled, for example, or for which a user or a motor vehicle is blocked, is immediately fulfilled in this case, whereas it occurs only after a certain error count in the case of a normal fulfillment of the error condition.

In some embodiments, a distance and/or an anticipated, especially a minimum driving time between the charging stations which detect the first and the respective second charging data set is determined, and the time limit value is determined in dependence on the distance and/or the anticipated driving time. The distance between the charging stations or the locations of the charging stations can be taken from map data, for example, or be stored in the respective charging station or a processing device carrying out the evaluation. However, position detection devices at the charging stations or a position detection of the respective motor vehicle which provides the position of the motor vehicle during the charging at the charging station can also be used.

Time limit values below which a situation is implausible can be determined from the positions or distances of the charging stations. For example, the time limit value can be chosen such that the user or the motor vehicle would have to move with a speed of more than 200 km/h or more than 300 km/h in a straight line between the charging stations in order to carry out the charging processes described by the charging data sets within the respective charging time intervals.

However, it is possible to use map data describing the traffic routes between the corresponding charging stations, especially with speed limitations, and/or traffic flow information, which is determined, for example, from swarm data and/or traffic radio information, and/or weather data in order to forecast the anticipated or minimum driving time between the charging stations. It is then possible to choose, as the time limit values, for example, a value which is 30% or 50% below the anticipated driving time.

The first charging data set can contain identification information regarding the charged motor vehicle and/or the user initiating and/or terminating the charging process, wherein each time charging data sets are determined for multiple different motor vehicles and/or for multiple different users regarding a charging of a respective motor vehicle at a respective charging station, wherein the respective charging data set contains identification information identifying the charged motor vehicle and/or the user initiating and/or terminating the charging process, wherein that charging data set or those charging data sets which contain the same identification information as the first charging data set are used as the second charging data set or the second charging data sets.

The saving of such identification information in a particular charging data set is often required any way, for example, in order to make possible a billing for charging fees. If the method described herein is carried out, for example, on a processing device which also serves for billing purposes, the information required to carry out the method is present in any case, so that the method can be carried out with minimal additional technical expense.

For example, the validation of a particular first charging data set can be done each time when a new charging data set is recognized by a charging station or provided to a processing device carrying out the method. This can then use all of the already available charging data sets or also only a subgroup of them, for example, all charging data sets detected within the last 24 hours or within the last week and pertaining to the same user or the same motor vehicle, as second charging data sets in order to test whether the first charging data set is consistent with these second charging data sets or not. In event of an inconsistency of the first charging data set with one of the second charging data sets, the error condition can be fulfilled and the steps explained below can be taken at once or, for example, after a certain number of errors have occurred.

Upon fulfillment of the error condition or a triggering condition dependent on the fulfillment of the error condition, the subsequent charging processes are blocked for the motor vehicle and/or by the user and/or a message is put out to a device external to the charging station and/or to the user. By a notification to the user or to a device external to the charging station, for example, a device of the charging station operator, the user or a charging station operator can be notified as to inconsistencies between the charging data sets. In this case, for example, a user can then scrutinize the next bill for the charging services and a service provider, for example, can already be notified specifically as to anticipated errors occurring.

On the other hand, a service provider can already recognize ahead of time that manipulations or technical errors are potentially occurring at its charging stations. For example, if errors occur with above-average frequency for certain users or motor vehicles, and thus the error condition is fulfilled especially frequently, this either points to a technical defect of this motor vehicle or a manipulation attempt by the user. In this case, the customer account of the user or the approval of the motor vehicle for charging may be temporarily blocked, for example, until the user has contacted the charging service provider in order to clarify the situation.

Each time the error condition can be evaluated for multiple first charging data sets, and upon each fulfillment of the error condition an error count is increased, and the triggering condition is fulfilled or can only be fulfilled if the error count is above a predetermined maximum error count or a maximum error frequency determined in dependence on the error count. In particular, the error condition can be checked after each detection of a new charging data set or after providing a new charging data set to a processing device for this charging data set as the first charging data set. In particular, all previously detected or provided charging data sets within a particular period of time regarding the particular motor vehicle or the particular user can be considered as the second charging data sets. The maximum error count or the maximum error frequency can be set manually or adapted automatically. For example, higher maximum error counts or maximum error frequencies may be set for long-time customers, business customers, or the like, until the customers or the motor vehicles are blocked.

Besides the method described herein, embodiments also relate to a system for validation of a first charging data set, comprising at least two charging stations for charging of motor vehicles and a processing device designed as part of one of the charging stations or separate from the charging stations, wherein the processing device is adapted to carry out the method described herein. The processing device, for example, can be provided by an appropriately programmed data processing device. The processing device can be, for example, a server of a charging network operator or a motor vehicle manufacturer. The communication between the respective charging station and the processing device can be wireline or wireless.

### BRIEF DESCRIPTION OF THE SEVERAL VIEWS OF THE DRAWINGS

Further advantages and details will emerge from the following embodiments as well as the accompanying drawings.

FIG. 1 shows an embodiment of a system and method for the validation of a first charging data set.

FIG. 2 shows the interaction of the algorithms and data structured used in the method used in FIG. 1.

FIG. 3 shows charging time intervals described by the charging data sets transmitted in an embodiment.

### DETAILED DESCRIPTION

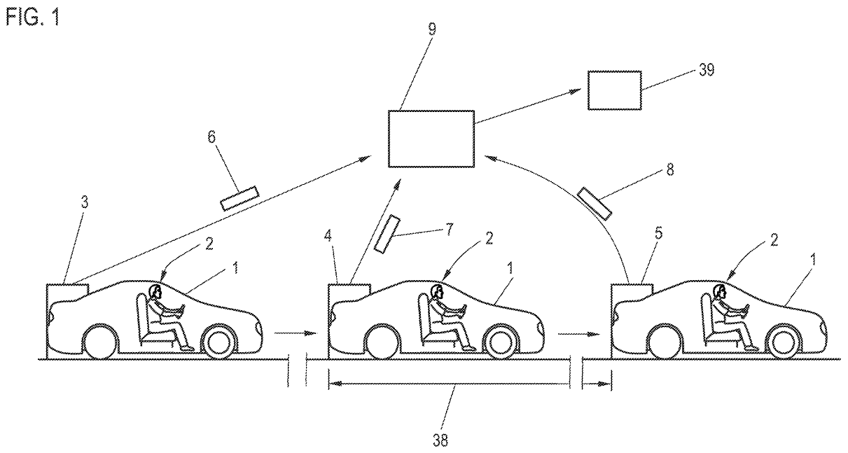

FIG. 1 shows a system and method for the validation of charging data sets 6-8. The system in the example comprises three charging stations 3-5 distant from one another and a processing device 9. In actual implementations, typically many more than three charging stations 3-5 are used. Nevertheless, the method can be implemented with two charging stations. In the example, the processing device 9 is configured separate from the charging stations 3-5 and it can be, for example, a server of the charging network operator or the vehicle manufacturer.

FIG. 1 shows a charging of the same motor vehicle 1 by the same user 2 at different times at the charging stations 3, 4, 5. Each time, a charging data set 6, 7, 8 is detected by the respective charging station 3, 4, 5 and provided to the processing device 9. This procedure is familiar in itself and serves, for example, for the billing of the amount of energy provided to the motor vehicle 1.

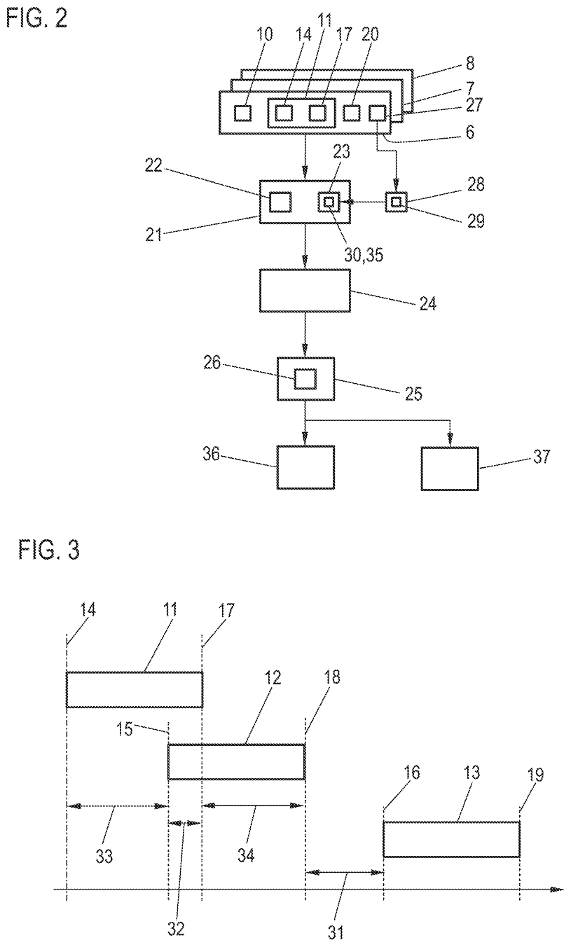

Situations may arise on account of technical errors or manipulation attempts in which the charging records are defective, for example, the identification information contained in them does not pertain to the correct motor vehicle or the correct user, the ending of a charging process was not correctly detected, and so on. Thanks to the check for consistency, explained further below with additional reference to FIG. 2, for a respective first charging data set 6-8 with second charging data sets 6-8 already available in regard to the same motor vehicle 1 or user 2, at least some of these errors can be recognized and an appropriate response can occur.

As shown in FIG. 2, the respective charging data set 6-8 can contain identification information 10 regarding the user 2 having initiated and/or terminated the respective charged motor vehicle 1 or the charging process. This facilitates billing the charging energy provided to the particular user or motor vehicle, for example. In the context of the method, however, the identification information 10 serves primarily for selecting second charging data sets 6-8 with the same identification information 10 for a particular newly detected first charging data set 6-8 being validated, in order to carry out the validation. For example, if the charging data set 8 is provided to the processing device 9 after the charging data sets 6, 7, the charging data set 8 can be validated by checking its consistency with the two charging data sets 6, 7 already present in regard to the same motor vehicle 1 or the same user 2.

For a particular pair of first and second charging data set 6-8, the fulfillment of an error condition 21 is tested, the fulfillment of which indicates the invalidity of the first or second charging data set 6-8 and being dependent on both charging data sets 6-8 of the particular pair. An example of the construction of the error condition will be explained more closely below.

In theory, it would be possible for a reaction to occur at once upon fulfillment of the error condition 21, i.e., to put out a message 36 to the user 2 or to a device 39 external to the charging station, for example, or even to block subsequent charging processes by the user 2 or the motor vehicle 1, for example, if there is a suspicion of a manipulation.

But often it is advisable to only initiate such steps when errors occur with frequency. Therefore, upon fulfillment of the error condition 21, at first an error count 24 is incremented and the mentioned responses, i.e., the putting out of the message 36 or the blocking 37, might only occur if a triggering condition 25 is fulfilled. This may be fulfilled, in particular, if the error count 24 rises above a maximum error count 26, which may be set adjustably, for example.

Instead of the absolute error count, it is also possible to compare an error frequency with a predetermined maximum error frequency. This can be accomplished, for example, by only counting errors within a predetermined time interval or within a predetermined number of detected charging data sets, or by dividing the error count with the total number of charging data sets considered or the time interval during which they were detected.

In the example, the charging data sets 6-8 each describe a charging time interval 11 during which the respective charging process occurs. In particular, the time for the beginning 14 and the end 17 of the respective charging process can be saved in the respective charging data set 6-8.

The error condition 21 in the example comprises two partial conditions 22, 23, and the fulfillment of one of these partial conditions 22, 23 is already sufficient to fulfill the error condition 21. Nevertheless, it would also be possible to use only the partial condition 22 or the partial condition 23 as the error condition 21. Both partial conditions in the example depend on the charging time intervals 11-13, the respective beginning 14-16 and the respective ending 17-19 of which are saved in the charging data sets 6-8. Therefore, the evaluation of the error condition 21 or the partial conditions 22, 23 will be explained in the following with further reference to FIG. 3, which visualizes the time sequence of these charging time intervals 11-13, the x-axis in the figure corresponding to the time axis.

The partial condition 22 is fulfilled if the charging time interval 11-13 of the first charging data set 6-8 overlaps with the charging time interval 11-13 of at least one of the two charging data sets 6-8 considered. If the first partial condition 22 is thus evaluated, for example, for the last detected charging data set 8, it is therefore not fulfilled, since the time interval 13 described by this, as is readily noticed in FIG. 3, does not overlap with the time intervals 11, 12 of the two charging data sets 6, 7 already available.

On the contrary, if the first partial condition 22 is evaluated for the charging data set 7 as the first charging data set, it will be recognized here that the charging time interval 12 of this charging data set 7 has an overlap 32 with the time interval 11 of the already available charging data set 6, and since these charging data sets 6, 7 pertain to the same motor vehicle 1, obviously one of these charging data sets 6, 7 must be defective, so that the error condition 21 is fulfilled.

The second partial condition 23 evaluates a time distance 31-33 between the beginning 14-16 or ending 17-19 of the charging time interval 11-13 of the first charging data set 6-8 from the beginning 14-16 or ending 17-19 of the charging time interval 11-13 of the respective second charging data set 6-8. The evaluation will be explained on the example of the charging data set 8 as the first charging data set and the charging data set 7 as the second charging data set, these charging data sets 7, 8 pertaining to the same motor vehicle 1. In this case, the time distance 31 between the ending 18 of the earlier charging time interval 12 and the beginning 16 of the later charging time interval 13 may be evaluated. The time distance 31 will be compared to a time limit value 30 and the partial condition 23 and thus the error condition 21 will be fulfilled in the example if the time distance 31 is less than the time limit value 30.

In the most simple case, the time limit value 30 could be a fixed value. For example, it is not very plausible for a further charging process to occur at another charging station already a few seconds or minutes after the ending of a charging process at a first charging station.

In some embodiments, a distance 38 between the relevant charging stations 4, 5, shown schematically in FIG. 1, will be considered. This is possible, for example, when the charging data sets 6-8 each contain position information 27, indicating the position of the respective charging station 3-5. Alternatively, for example, preliminary information could be stored in the processing device 9 regarding the positions of the individual charging stations 3-5 or the distances between them.

The time limit value 30 in the most simple case can be determined by a predetermined relationship, for example, continuously or discretely in several steps, depending on the distance 38.

In some embodiments, a driving time prediction 28 will be used in order to determine an anticipated, especially a minimum driving time between the charging stations 4, 5 registering the charging data sets 7, 8, for example, based on map data 29 describing the travel routes which can be used between the charging stations 3-5 and the speed limits there. This driving time 35 is used directly as the time limit value 30 in the example. However, the anticipated driving time 35 could also be scaled, for example cut in half, in order to dictate the time limit value 30.

In the example explained, all the charging data sets 6-8 for which the consistency is being checked pertain to the same motor vehicle 1. In some embodiments, the consistency test is also feasible when the charging data sets 6-8 pertain to different motor vehicles, but all the charging processes are initiated or terminated by the same user 2.

For example, a user can use the identification information 10 assigned to him in order to authorize charging processes of different motor vehicles, or there can be a common billing for different motor vehicles of the same user 2. In this case, however, it may in fact be possible for charging time intervals 11-13 during which these different motor vehicles are being charged to overlap. Thus, the above explained partial condition 22 might also be fulfilled in cases in which all charging data sets 6-8 considered are in fact valid.

Nevertheless, in order to accomplish a robust consistency check between the different charging data sets 6-8, one can utilize the fact that the user 2 in general must perform actions at the beginning 14-16 or ending 17-19 of the particular charging time interval 11-13 at the particular charging station 3-5 or at the motor vehicle being charged there. Since it is necessary for the user to move between the charging stations 3-5 for this, in this case the time distances 31, 33, 34 between different actions or the limits of the charging time intervals 11-13 or also the length of the overlap 32 which likewise indicates the time distance between actions may be compared against the time limit value 30 which is chosen or determined as explained above, and once again a falling short of the time limit value 30 will indicate that the sequence of actions as described by the charging data sets 6-8 is not in fact possible and thus the charging data sets 6-8 are inconsistent.

If it is established that the particular first charging data set 6-8 is consistent with the preceding or second charging data sets 6-8, then it can be used for billing purposes. In this case, for example, additional billing information 20 regarding the charging power provided during the particular charging time interval 11-13 or the total charging energy provided can be taken into consideration.

On the other hand, if the error condition 21 is fulfilled, then in the most simple case the first charging data set for which the validation was done can be rejected and not considered during the billing. Nevertheless, it is also possible to consider the nonvalidated charging data set proportionally in the billing. For example, in event of an overlap of time intervals 11, 12 of two charging data sets 6, 7, the overlap 32 can be billed only in one of the two charging data sets 6, 7. In addition, the time interval 11-13 used in the billing can be reduced, in event of a fulfillment of the error condition 21, in dependence on the distance 38 or the anticipated driving time 35 between the charging stations 3-5.

German patent application no. 10 2021 128708.1, filed Nov. 4, 2021, to which this application claims priority, is hereby incorporated herein by reference in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for validation of a first charging data set, regarding a charging process of a motor vehicle at a first charging station and detected by the first charging station, the method comprising: detecting a respective second charging data set, by at least one second charging station, regarding at least one respective second charging process during which the same motor vehicle is charged and/or the charging process is initiated and/or terminated by the same user,
testing the fulfillment of an error condition, the fulfillment of which indicates the invalidity of the first and/or the second charging data set and is dependent on both the first charging data set and the second charging data set.

2. The method according to claim 1, wherein the first and second charging data set each describe a charging time interval in which the respective charging process occurs, wherein the error condition is fulfilled or it can only be fulfilled if the charging time interval of the first charging data set overlaps with the charging time interval of the second charging data set or at least one of the second charging data sets.

3. The method according to claim 1, wherein the first and second charging data set each describe the charging time interval or a charging time interval in which the respective charging process occurs, wherein the error condition is fulfilled or it can only be fulfilled if a time distance between the beginning or end of the charging time interval of the first charging data set and the beginning or end of the charging time interval of the second charging data set or at least one of the second charging data sets falls below a time limit value.

4. The method according to claim 1, wherein a distance and/or an anticipated driving time between the charging stations which detect the first and the respective second charging data set is determined, and the time limit value is determined in dependence on the distance and/or the anticipated driving time.

5. The method according to claim 1, wherein a distance and/or a minimum driving time between the charging stations which detect the first and the respective second charging data set is determined, and the time limit value is determined in dependence on the distance and/or the minimum driving time.

6. The method according to claim 1, wherein the first charging data set contains identification information regarding the charged motor vehicle and/or the user initiating and/or terminating the charging process, wherein each time charging data sets are determined for multiple different motor vehicles and/or for multiple different users regarding a charging of a respective motor vehicle at a respective charging station, wherein the respective charging data set contains identification information identifying the charged motor vehicle and/or the user initiating and/or terminating the charging process, wherein that charging data set or those charging data sets which contain the same identification information as the first charging data set are used as the second charging data set or the second charging data sets.

7. The method according to claim 1, wherein upon fulfillment of the error condition or a triggering condition dependent on the fulfillment of the error condition the subsequent charging processes are blocked for the motor vehicle and/or by the user and/or a message is put out to a device external to the charging station and/or to the user.

8. The method according to claim 7, wherein each time the error condition is evaluated for multiple first charging data sets, and upon each fulfillment of the error condition an error count is increased, and the triggering condition is fulfilled or can only be fulfilled if the error count is above a predetermined maximum error count or a maximum error frequency determined in dependence on the error count.

9. A system for validation of a first charging data set regarding a first charging process of a motor vehicle at a first charging station and detected by the first charging station, comprising:
the first charging station;
a second charging station for charging of motor vehicles; and
a processing device designed as part of one of the charging stations or separate from the charging stations, wherein the processing device is adapted to carry out a method comprising:
detecting a respective second charging data set, by the second charging station, regarding at least one respective second charging process during which the same motor vehicle is charged and/or the charging process is initiated and/or terminated by the same user,
testing the fulfillment of an error condition, the fulfillment of which indicates the invalidity of the first and/or the second charging data set and is dependent on both the first charging data set and the second charging data set.
